(19) United States
(12) Patent Application Publication
(10) Pub. No.: US 2017/0147441 A1
(43) Pub. Date: May 25, 2017

(54) Selective Data Roll-Back and Roll-Forward

(71) Applicant: NetApp, Inc., Sunnyvale, CA (US)

(72) Inventors: Charles Binford, Wichita, KS (US); Reid Kaufmann, Wichita, KS (US); Jeff Weide, Wichita, KS (US)

(21) Appl. No.: 14/947,816

(22) Filed: Nov. 20, 2015

(51) Int. Cl. G06F 11/14; G06F 3/06

(52) U.S. Cl. CPC G06F 11/1451; G06F 3/0619; G06F 3/0665; G06F 3/065; G06F 3/067; G06F 11/1464; G06F 11/1471; G06F 11/1435; G06F 2201/80; G06F 2201/84

(57) ABSTRACT

A system and method for recovering a dataset is provided that analyzes the dataset as it currently exists in order to determine those portions that do not need to be recovered. In some embodiments, the method includes identifying a dataset stored on a set of storage devices and corresponding to a first point in time. A request to restore the dataset to a second point in time is received, and a subset of the dataset is identified that is different between the first point in time and the second point in time. Data associated with the subset is selectively retrieved that corresponds to the second point in time, and the retrieved data is merged with the dataset stored on the set of storage devices. The two points in time may have any relationship, and in various examples, the method performs a roll-back or a roll-forward of the dataset.

### TECHNICAL FIELD

The present description relates to data backup, and more specifically, to a technique for the roll-back or roll-forward of a dataset in order to restore it as it existed at a different point in time.

### BACKGROUND

Networks and distributed storage allow data and storage space to be shared between devices located anywhere a connection is available. These implementations may range from a single machine offering a shared drive over a home network to an enterprise-class cloud storage array with multiple copies of data distributed throughout the world. Larger implementations may incorporate Network Attached Storage (NAS) devices, Storage Area Network (SAN) devices, and other configurations of storage elements and controllers in order to provide data and manage its flow. Improvements in distributed storage have given rise to a cycle where applications demand increasing amounts of data delivered with reduced latency, greater reliability, and greater throughput. Hand-in-hand with this trend, system administrators have taken advantage of falling storage prices to add capacity wherever possible.

However, one drawback to this abundance of cheap storage is the need to maintain and organize regular backup copies of increasing amounts of data. In many instances, merely identifying the correct backup copy to recover data can be problematic. Take an example where a file is deleted, corrupted, or inadvertently modified. There is no guarantee that a user can identify precisely when the file was altered or which backup copy had the most recent version before the alteration.

One solution is to work backwards by restoring the most recent backup copy and if the file is still deleted, corrupted, or modified, restoring the next most recent backup. However, recovery operations remain extremely time-consuming processes due, in part, to ever-increasing volume sizes. In typical examples, it takes hours or even days to recover a dataset from a backup, and other transactions may be delayed while data is being restored. This is an extremely long amount of time for a system to be operating at reduced capacity, and thus restoring several backup copies sequentially may be unacceptable. On the other hand, while it may be possible to restore backup copies in parallel, few systems would have sufficient storage for multiple concurrent copies of a substantial dataset. Thus, while existing techniques for data protection have been generally adequate, the techniques described herein provide more efficient data recovery, and in many examples, allow a system to quickly transition forward and backward through different versions of the dataset corresponding to different points in time.

### BRIEF DESCRIPTION OF THE DRAWINGS

The present disclosure is best understood from the following detailed description when read with the accompanying figures.

FIG. 1 is a schematic diagram of a computing architecture according to aspects of the present disclosure.

FIG. 2 is a schematic diagram of a computing architecture including an object-based backup system according to aspects of the present disclosure.

FIG. 3 is a memory diagram of the contents of an object store of an object-based backup system according to aspects of the present disclosure.

FIG. 4 is a flow diagram of a method of recovering data according to aspects of the present disclosure.

### DETAILED DESCRIPTION

All examples and illustrative references are non-limiting and should not be used to limit the claims to specific implementations and embodiments described herein and their equivalents. For simplicity, reference numbers may be repeated between various examples. This repetition is for clarity only and does not dictate a relationship between the respective embodiments. Finally, in view of this disclosure, particular features described in relation to one aspect or embodiment may be applied to other disclosed aspects or embodiments of the disclosure, even though not specifically shown in the drawings or described in the text.

Various embodiments include systems, methods, and machine-readable media for recovering data from a backup. In an exemplary embodiment, a storage system that currently contains a copy of a volume or other dataset receives a request to recover the dataset as it existed at a different point in time. For example, the storage system may have the latest copy of a volume, but the request may instruct it to recover the volume as it stood a week ago. The storage system queries a manifest stored on a data-recovery object store and determines that the object store contains multiple backup copies corresponding to different points in time. These may include full backup copies with recovery data objects for the entire address space and/or incremental backup copies that only contain recovery objects for data that was modified since the previous backup copy. For an incremental backup, unchanged data may be represented by references (e.g., pointers) to recovery objects 204 that were backed up as part of a previous recovery point.

The system recovering the data from the backup utilizes information in the manifests and/or a local write log to identify and retrieve only those portions of the dataset that have changed between the dataset as it currently stands and the dataset being restored. In other words, rather than retrieving all the data and recovering the entire dataset from scratch, in the example, the storage system may restore only those address ranges that have changed. The storage system retrieves the respective recovery objects and applies the data contained therein to the current dataset by merging (i.e., replacing current data with retrieved data when retrieved data is available for a given address) so that the dataset matches its state at the requested point in time. This operation may be referred to as a roll-back when a dataset is restored to a previous point in time and referred to as a roll-forward when a dataset is restored to a subsequent point in time. As will be recognized, the present technique only recovers those data objects that have changed, allowing the storage system to quickly transition forward and back between versions even when the data connection between the storage system and the data store is slow.

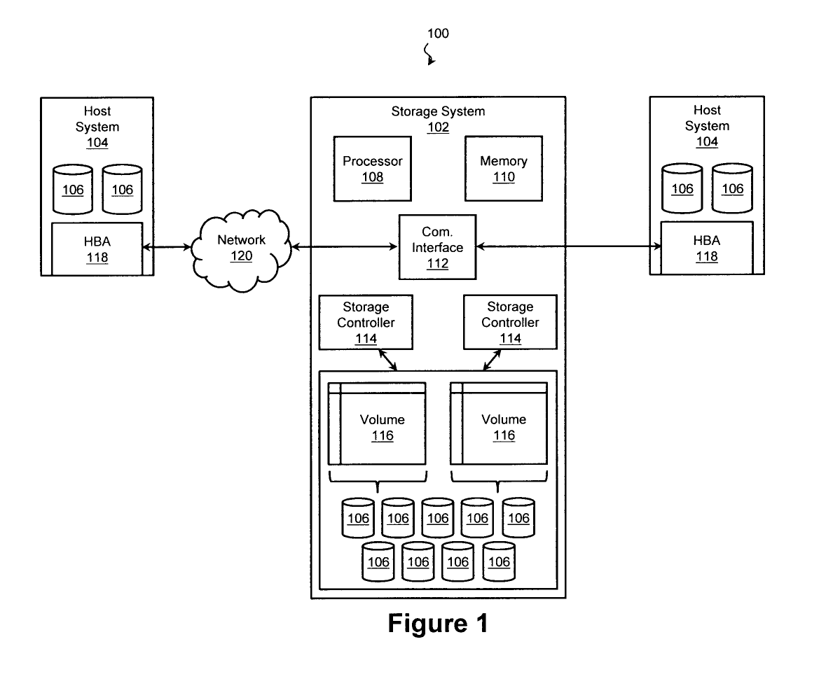

FIG. 1 is a schematic diagram of a computing architecture 100 according to aspects of the present disclosure. The computing architecture 100 includes a number of computing systems, including one or more storage systems 102 and one or more host systems 104 (hosts), each of which may store and manipulate data. Techniques for preserving and restoring this data are described with reference to the figures that follow.

In the illustrated embodiment, the computing architecture 100 includes one or more storage systems 102 in communication with one or more hosts 104. It is understood that for clarity and ease of explanation, only a single storage system 102 and a limited number of hosts 104 are illustrated, although the computing architecture 100 may include any number of hosts 104 in communication with any number of storage systems 102. An exemplary storage system 102 receives data transactions (e.g., requests to read and/or write data) from the hosts 104 and takes an action such as reading, writing, or otherwise accessing the requested data so that storage devices 106 of the storage system 102 appear to be directly connected (local) to the hosts 104. This allows an application running on a host 104 to issue transactions directed to storage devices 106 of the storage system 102 and thereby access data on the storage system 102 as easily as it can access data on the storage devices 106 of the host 104. In that regard, the storage devices 106 of the storage system 102 and the hosts 104 may include hard disk drives (HDDs), solid state drives (SSDs), RAM drives, optical drives, and/or any other suitable volatile or non-volatile data storage medium.

While the storage system 102 and the hosts 104 are referred to as singular entities, a storage system 102 or host 104 may include any number of computing devices and may range from a single computing system to a system cluster of any size. Accordingly, each storage system 102 and host 104 includes at least one computing system, which in turn includes a processor 108 such as a microcontroller or a central processing unit (CPU) operable to perform various computing instructions. The computing system may also include a memory device 110 such as random access memory (RAM); a non-transitory computer-readable storage medium such as a magnetic hard disk drive (HDD), a solid-state drive (SSD), or an optical memory (e.g., CD-ROM, DVD, BD); a video controller such as a graphics processing unit (GPU); a communication interface 112 such as an Ethernet interface, a Wi-Fi (IEEE 802.11 or other suitable standard) interface, or any other suitable wired or wireless communication interface; and/or a user I/O interface coupled to one or more user I/O devices such as a keyboard, mouse, pointing device, or touchscreen.

With respect to the storage system 102, the exemplary storage system 102 contains any number of storage devices 106 in communication with one or more storage controllers 114. The storage controllers 114 exercise low-level control over the storage devices 106 in order to execute (perform) data transactions on behalf of the hosts 104, and in so doing, may group the storage devices for speed and/or redundancy using a virtualization technique such as RAID (Redundant Array of Independent/Inexpensive Disks). At a high level, virtualization includes mapping physical addresses of the storage devices into a virtual address space and presenting the virtual address space to the hosts 104. In this way, the storage system 102 represents the group of devices as a single device, often referred to as a volume 116. Thus, a host 104 can access the volume 116 without concern for how it is distributed among the underlying storage devices 106.

Turning now to the hosts 104, a host 104 includes any computing resource that is operable to exchange data with a storage system 102 by providing (initiating) data transactions to the storage system 102. In an exemplary embodiment, a host 104 includes a host bus adapter (HBA) 118 in communication with a storage controller 114 of the storage system 102. The HBA 118 provides an interface for communicating with the storage controller 114, and in that regard, may conform to any suitable hardware and/or software protocol. In various embodiments, the HBAs 118 include Serial Attached SCSI (SAS), iSCSI, InfiniBand, Fibre Channel, and/or Fibre Channel over Ethernet (FCoE) bus adapters. Other suitable protocols include SATA, eSATA, PATA, USB, and FireWire. In many embodiments, the host HBAs 118 are coupled to the storage system 102 via a network 120, which may include any number of wired and/or wireless networks such as a Local Area Network (LAN), an Ethernet subnet, a PCI or PCIe subnet, a switched PCIe subnet, a Wide Area Network (WAN), a Metropolitan Area Network (MAN), the Internet, or the like. To interact with (e.g., read, write, modify, etc.) remote data, the HBA 118 of a host 104 sends one or more data transactions to the storage system 102 via the network 120. Data transactions may contain fields that encode a command, data (i.e., information read or written by an application), metadata (i.e., information used by a storage system to store, retrieve, or otherwise manipulate the data such as a physical address, a logical address, a current location, data attributes, etc.), and/or any other relevant information.

Thus, a user of the exemplary computing architecture 100 may have data stored on one or more hosts 104 as well as on the storage system 102. In order to preserve this data, backup copies may be made at regular intervals and preserved so that they can be restored later. In many embodiments, the backup copies are stored on different storage devices 106 and/or different computing systems to protect against a single point of failure compromising both the original and the backup. Any suitable backup technique may be used to preserve the data on the storage devices 106 of the hosts 104 and/or storage system 102.

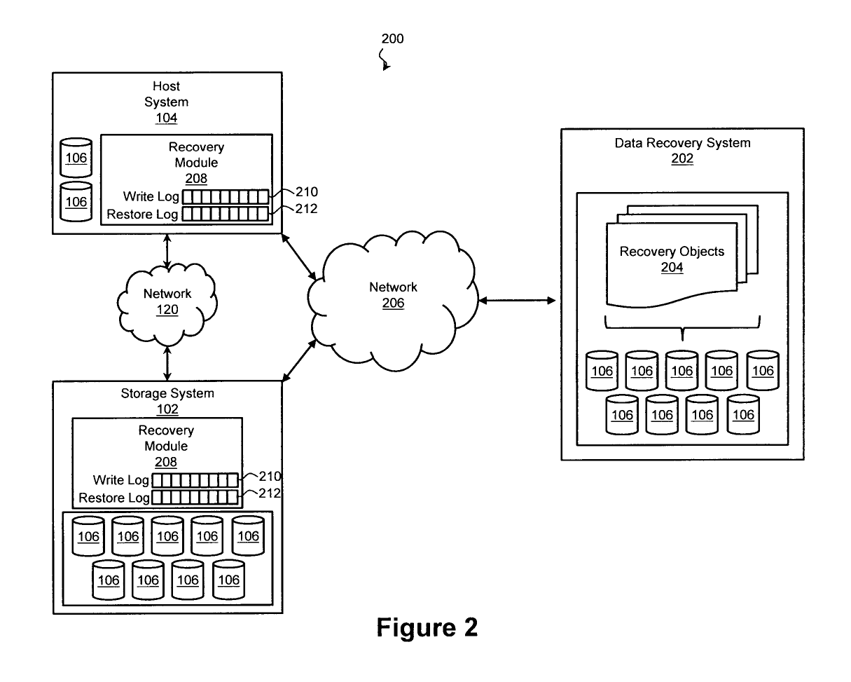

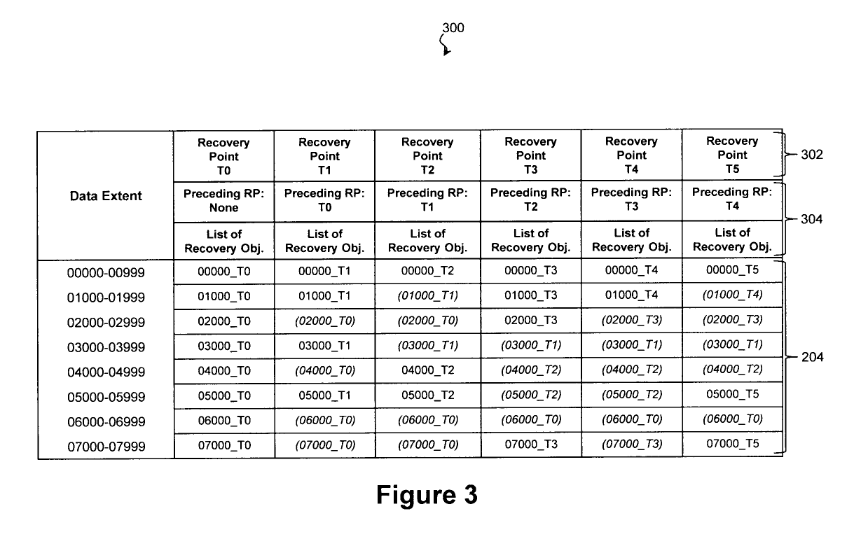

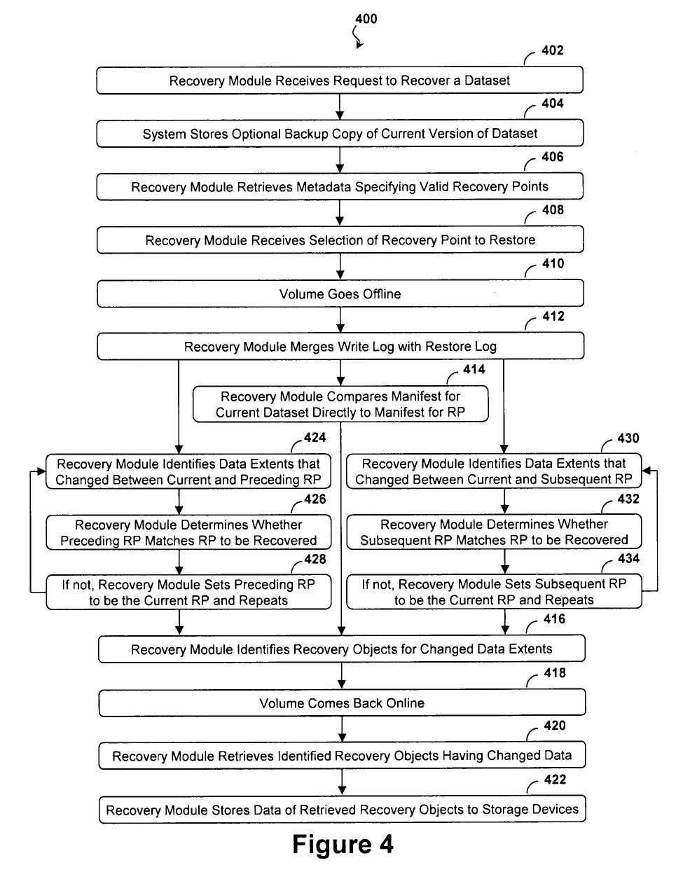

An exemplary technique for restoring data from an object data store is disclosed with reference to FIGS. 2 through 4. The object data store is merely one example of a repository where the backup copy may be stored, and the present technique is equally applicable regardless of where the backup is actually stored. In that regard, other backup repositories are both contemplated and provided for. FIG. 2 is a schematic diagram of a computing architecture 200 including an object-based backup system according to aspects of the present disclosure. FIG. 3 is a memory diagram of the contents of an object store of an object-based backup system according to aspects of the present disclosure. FIG. 4 is a flow diagram of a method 400 of recovering data according to aspects of the present disclosure. It is understood that additional steps can be provided before, during, and after the steps of method 400, and that some of the steps described can be replaced or eliminated for other embodiments of the method.

Referring first to FIG. 2, the illustrated computing architecture 200 may be substantially similar to the computing architecture 100 of FIG. 1 and may include one or more hosts 104 and storage systems 102, each substantially similar to those of FIG. 1. The host(s) 104 and storage system(s) 102 are communicatively coupled to a data recovery system 202, upon which is stored backup copies of data obtained from the host(s) 104 and/or the storage system 102. Accordingly, any or all of the host(s) 104 and/or the storage system 102 may contain a recovery module 208 in communication with the data recovery system 202 to perform data backup and recovery processes.

In order to store and retrieve this data, the recovery module(s) 208 of the host(s) 104 and/or the storage system 102 may communicate with the data recovery system 202 using HTTP, an object-level protocol, over a network 206, which may be substantially similar to network 120. In that regard, network 206 may include any number of wired and/or wireless networks such as a LAN, an Ethernet subnet, a PCI or PCIe subnet, a switched PCIe subnet, a WAN, a MAN, the Internet, or the like, and may be part of network 120 or may be a completely different network. In the example, network 120 is an intranet (e.g., a LAN or WAN), while network 206 is the Internet.

As with the host 104 and the storage system 102, while the data recovery system 202 is referred to as a singular entity, it may include any number of computing devices and may range from a single computing system to a system cluster of any size. Accordingly, the data recovery system 202 includes at least one computing system, which in turn includes a processor, a memory device, a video controller such as a graphics processing unit (GPU), a communication interface, and/or a user I/O interface. The data recovery system 202 also contains one or more storage devices 106 having recovery data stored thereupon. Either or both of the host 104 and the storage system 102 may store backup copies of their data on the data recovery system 202 and may recover backup data from the data recovery system 202.

The data recovery system 202 may be an object-based data system and may store the backup data as one or more recovery objects 204. In brief, object-based data systems provide a level of abstraction that allows data of any arbitrary size to be specified by an object identifier. In contrast, block-level data transactions refer to data using an address that corresponds to a sector of a storage device and may include a physical address (i.e., an address that directly map to a storage device) and/or a logical address (i.e., an address that is translated into a physical address of a storage device). Exemplary block-level protocols include iSCSI, Fibre Channel, and Fibre Channel over Ethernet (FCoE). As an alternative to block-level protocols, file-level protocols specify data locations by a file name. A file name is an identifier within a file system that can be used to uniquely identify corresponding memory addresses. File-level protocols rely on a computing system to translate the file name into respective storage device addresses. Exemplary file-level protocols include CIFS/SMB, SAMBA, and NFS. Object-level protocols are similar to file-level protocols in that data is specified via an object identifier that is eventually translated by a computing system into a storage device address. However, objects are more flexible groupings of data and may specify a cluster of data within a file or spread across multiple files. Object-level protocols include CDMI, HTTP, SWIFT, and S3.

A simple example of an object-based collection of backup data is explained with reference to FIG. 3. The memory diagram 300 of FIG. 3 shows the recovery objects 204 stored in the data recovery system 202, which correspond to six points in time (recovery points), T0-T5, with T0 being the earliest. The data recovery system 202 may store a recovery point list 302 (a type of metadata-containing data object) that identifies each recovery point, and each recovery point may have a corresponding recovery point manifest 304 (another type of metadata-containing data object) that records those recovery objects associated with the respective recovery point. In this example, each recovery object is named based on a corresponding block range and a timestamp (e.g., “01000_T0”). The data recovery system 202 supports incremental backups where unchanged data is not duplicated with a new timestamp. Instead, the manifest 304 for a recovery point may simply refer to recovery objects from other recovery points.

For example, the manifest 304 for recovery point T3 may specify those recovery objects with a timestamp T3, and for address ranges where a T3-stamped recovery object is not available, the manifest 304 may specify recovery objects from other recovery points. In FIG. 3, pointers to recovery objects 204 from other recovery points are indicated with parenthesis and italics. In the example, the manifest 304 includes the recovery objects: {00000_T3, 01000_T3, 02000_T3, 03000_T1, 04000_T2, 05000_T2, 06000_T0, and 07000_T3}. Object 01000_1′4 would not be included because T4 represents data that was changed after recovery point T3. Similarly, object 04000_T0 would not be included because object 04000_T2 is newer and represents the data at time T3. A recovery module 208 running on a host 104, storage system 102, or other system can use the manifest 304 to restore the data by retrieving each and every recovery object 204 associated with the specified recovery point. However, in the embodiments, that follow, the recovery module 208 makes an assessment of data that already exists on the storage devices 106 and selectively retrieves those recovery objects 204 that have different data. This provides a substantial and significant improvement to conventional systems for data recovery.

One such improved recovery technique is described in method 400 of FIG. 4. The data to be recovered is stored on the data recovery system 202, and being object-based, it is stored as one or more recovery objects 204, each containing data stored in various block ranges (data extents) of an address space. Other data objects stored on the data recovery system 202 contain configuration data, metadata, or other information, as described in more detail below. In the method that follows, the recovery objects 204 and metadata-containing objects are used to recover the dataset block-by-block, and accordingly some examples of the technique may be described as block-based recovery from an object-based repository.

Referring first to block 402 of FIG. 4 and referring back to FIG. 2, a recovery module 208 of a restoring system (e.g., a host 104, a storage system 102, or a third-party system) receives a request to recover a dataset on a target system (e.g., a host 104, a storage system 102, or a third-party system). The restoring system containing the recovery module 208 may be the same or different, such as a host 104 acting as a restoring system and a storage system 102 acting as a target system. In some of the examples that follow, the dataset is a single volume, although the dataset may have any arbitrary size. The request may be a user request or an automated request and may be provided by a user, another program, or any other suitable source.

As explained below, the recovery module 208 recognizes that the target system already has a copy of the dataset stored upon its storage devices 106 and determines those portions of the existing dataset that differ from the recovery point being restored. Using this information, the recovery module 208 may then restore only those portions of the dataset that are different.

Because recovering the data may involve overwriting the dataset as it currently stands on the target system, before acting on the request, a backup copy of the dataset currently on the storage devices 106 of the target system may be made as shown in block 404. One such technique involves backing up data to an object storage service and is disclosed in U.S. patent application Ser. No. 14/521,053, filed Oct. 22, 2014, by William Hetrick et al., entitled “DATA BACKUP TECHNIQUE FOR BACKING UP DATA TO AN OBJECT STORAGE SERVICE”, the entire disclosure of which is herein incorporated in its entirety.

In brief, a computing system (e.g., storage system 102) may maintain a write log 210 to track data extents that have been modified since the last backup copy was made. The write log 210 contains a number of entries that record whether data has been written or otherwise modified. The write log 210 may take the form of bitmap, a hash table, a flat file, an associative array, a linked list, a tree, a state table, a relational database, and/or other suitable memory structure. The write log 210 may divide the address space according to any granularity and, in various exemplary embodiments, the write log 210 divides the address space into segments having a size between 64 KB and 4 MB. To back up the data, the system constructs recovery objects 204 for the modified data extents recorded in the write log 210. Metadata such as timestamps, permissions, encryption status, and/or other suitable metadata corresponding to the modified data may be added to the recovery object 204 or any other data object such as a manifest 304.

The system determines whether an incremental backup or a full backup is being performed. For an incremental backup, data extents that contain only unmodified data can be excluded, and the system performing the data backup may store only those recovery objects 204 that contained modified data on the data recovery system 202. The system may also create and store one or more metadata-containing data objects on the data recovery system 202 such as the aforementioned a manifest 304 specifying the current recovery point and a list of the associated recovery objects 204. Finally, the system may create or modify a recovery point list 302 stored on the data recovery system 202 to include a timestamp and/or a reference to the current recovery point.

For a full backup, the system performing the data backup stores recovery objects 204 for all the data extents in the address space on the data recovery system 202. For data extents that contain only unmodified data, the system performing the data backup may create and provide recovery objects 204 or may instruct the data recovery system 202 to copy the unmodified recovery objects 204 from another recovery point already stored on the data recovery system 202. Copying directly avoids burdening the network 206 with exchanging new recovery objects 204 that are substantially the same as the existing recovery objects 204. Here as well, the system performing the data backup may create and store one or more metadata-containing data objects such as recovery point list 302 or manifest 304 on the data recovery system 202.

Once the optional backup has been performed, the recovery module 208 may continue processing the request to recover the dataset. If the request of block 402 does not specify a particular recovery point, the recovery module 208 retrieves the recovery point list 302 from the data recovery system 202 as shown in block 406. Valid recovery points are those where the entire requested address range is available. In the example of FIG. 3, T0 is a valid recovery point because the manifest 304 specifies a recovery object 204 with a timestamp of T0 for each data extent in the address space. While T1 does not have a recovery object 204 with a timestamp of T1 for each data extent, it references recovery objects 204 from previous recovery points for data that did not change. Accordingly, the data at time T1 can be recovered using recovery objects: {00000_T1, 01000_T1, 02000_T0, 03000_T1, 04000_T0, 05000_T1, 06000_T0, 07000_T0}, which correspond to the recovery objects 204 with a timestamp of T1, where available, and otherwise to the recovery objects 204 of the preceding recovery point, T0. When the dataset currently on the target system is newer than the recovery point being recovered, the operation may be referred to as a roll-back. Similarly, when the dataset currently on the target system is older than the recovery point being recovered, the operation may be referred to as a roll-forward.

Referring to block 408, the recovery module 208 receives a selection of a recovery point to restore. This may include providing a list of valid recovery points at a user interface, an application interface, and/or other suitable interface, and receiving a user command selecting a recovery point. Referring to block 410, the volume may be taken offline temporarily as the recovery module identifies the data to be restored.

The recovery module 208 compares the dataset currently on the storage devices 106 of the target system to the dataset to be recovered in order to determine which recovery objects 204 to retrieve. As explained above, rather than recovering the entire dataset from scratch, the recovery module 208 may identify only those recovery objects 204 with data that is different and merge the recovery objects 204 with the data already on the storage devices 106.

The recovery module 208 may use any suitable technique to identify the recovery objects 204 with data that differs, and in some exemplary embodiments, the recovery module 208 compares the most recent manifest 304 (and write log 210, if any) associated with the target system to the manifest 304 associated with the selected recovery point to determine the address ranges having data that differs, as shown in blocks 412 and 414. Referring to block 412, if the write log 210 records that any data has been modified since the last backup and recovery point, the write log 210 is merged with a restore log 212 (or more accurately a “need-to-restore log”). The restore log 212 may take the form of bitmap, a hash table, a flat file, an associative array, a linked list, a tree, a state table, a relational database, and/or other suitable memory structure. The restore log 212 may divide the address space according to any granularity and, in various exemplary embodiments, the restore log 212 divides the address space into segments having a size between 64 KB and 4 MB. After merging, the restore log 212 will record that the any data that has been modified since the last recovery point is to be restored.

Referring to block 414, the recovery module compares a copy of the most recent manifest 304 (and write log 210, if any) associated with the target system to the manifest 304 associated with the selected recovery point. In some such embodiments, the target system stores a copy of the most recent manifest 304 locally, although the recovery module 208 may retrieve either manifest from the data recovery system 202 and may save the manifests locally if they are not already present.

In an example referring to FIG. 3, recovery point T5 corresponds to the backup performed in block 404 and represents the dataset as a currently stands on the storage devices 106 of the target system (meaning that the write log 210 has not recorded any changes since the backup). In the example, the request instructs the recovery module 208 to restore the dataset at recovery point T2, and therefore, the recovery module 208 determines those recovery objects 204 that have changed between recovery points T2 and T5. The recovery module 208 compares the manifest 304 associated with recovery point T5 to the manifest 304 associated with recovery point T2 and determines that, in the example of FIG. 3, the data extents to be recovered are: {00000-00999, 01000-01999, 02000-02999, 05000-05999, and 07000-07999} because these data extents refer to different data objects. The recovery module 208 determines that the data extent {03000-03999}, for example, does not need to be recovered because both manifests 304 refer to the same data object (03000_T1).

The recovery module 208 records the recovery objects 204 with data that has changed and/or their associated data extents in the restore log 212. In the example of FIG. 3, the recovery module 208 determines that data extents: {00000-00999, 01000-01999, 02000-02999, 05000-05999, and 07000-07999} have data that has been changed between T2 and T5 and records them in the restore log 212.

The restore log 212 may record data to be restored by associated data extent, associated recovery object, and/or any other suitable identifier. If the restore log 212 does not identify the specific recovery objects 204 used to recover the data, referring to block 416 of FIG. 4, for each data extent in the restore log 212, the recovery module 208 then identifies from the manifest 304 of the recovery point being restored (e.g., T2) those recovery objects 204 that contain the data as it existed at that point in time. In the example of FIG. 3, recovery objects 204 for recovery point T2 include {00000_T2, 01000_T1, 02000_T0, 05000_T2, and 07000_T0}. After the recovery objects 204 have been identified, the volume may be brought back online as shown in block 418

Once the recovery objects 204 of the restore log 212 have been identified, referring to block 420 of FIG. 4, the recovery module 208 retrieves the respective recovery objects 204 from the data recovery system 202. The recovery objects 204 may be retrieved in any order. For example, in some embodiments, the target system continues to service data transactions received during the recovery process, and transactions that read or write the data of a recovery object 204 cause the recovery module 208 to retrieve the respective recovery object 204 sooner, sometimes immediately. In this way, the transactions need not wait for the recovery process to complete entirely. Retrieving a recovery object 204 with a pending transaction may or may not interrupt the retrieval of a lower-priority recovery object 204 that is already in progress. A suitable technique for retrieving recovery objects from object storage service is disclosed in U.S. patent application Ser. No. 14/937,192, filed Nov. 10, 2015, by Mitch Blackburn et al., entitled “PRIORITIZED DATA RECOVERY FROM AN OBJECT STORAGE SERVICE AND CONCURRENT DATA BACKUP”, the entire disclosure of which is herein incorporated in its entirety.

As part of block 420, in some embodiments, the data recovery system 202 encrypts, decrypts, compresses, or uncompresses the recovery objects 204 prior to transmission to the recovery module 208. As with all exchanges between the recovery module 208 and the data recovery system 202, the transmission of the recovery objects 204 utilize any suitable protocol. In an exemplary embodiment, the recovery objects 204 are transmitted to the recovery module 208 using HTTP requests and responses transmitted over the network 206.

Referring to block 422 of FIG. 4, as the recovery objects are received, the recovery module 208 merges the recovery data contained therein with the existing dataset by writing the recovery to the storage devices 106 at block addresses (physical and/or virtual) determined by the data extents of the respective recovery objects 204. Accordingly, the recovery data is written to the exact block address that it was at when it was backed up using address identifiers incorporated into the recovery objects 204. By doing so, the recovery module 208 overwrites the existing data on the storage devices 106 with the recovery data. As will be recognized, only the data that differs between, for example, T5 and T2 (and optionally some unchanged data used to pad out the recovery objects 204) is retrieved from the data recovery system 202 and restored. In this way, the recovery module 208 restores the dataset to its condition at time T2 without restoring each and every recovery object 204 in the address space. This can substantially reduce the burden on the connection (e.g., network 206) between the recovery module 208 and the data recovery system 202. In a typical example, less than 10% of the address space is retrieved in order to restore the recovery point. This makes the technique well-suited for cloud-based data recovery systems 202, where network capacity and latency may be non-trivial.

While the preceding example described a roll-back that restored a dataset from a state at T5 to a state at T2, the technique of blocks 412-422 is equally applicable when performing a roll-forward when a subsequent recovery point is selected in block 408 (for example, when restoring the dataset from a state at T2 to a state at T4).

Instead of comparing the manifests 304 directly, in some embodiments, the recovery module 208 traces a chain of recovery points until it reaches the recovery point being restored. An example of tracing a recovery point chain backwards to perform a roll-back is described with reference to blocks 424-428, and an example of tracing a recovery point chain forwards to perform a roll-forwards is described with reference to blocks 430-434.

Turning first to a roll-back procedure, similar to the previous example, recovery point T5 corresponds to the backup performed in block 404 and represents the dataset as a currently stands on the storage devices 106 of the target system. In the example, the request instructs the recovery module 208 to restore the dataset at recovery point T2, and therefore, the recovery module 208 determines those recovery objects 204 that have changed between recovery points T2 and T5.

Referring to block 424 of FIG. 4, the recovery module 208 identifies a recovery point (e.g., T4) immediately preceding the current recovery point on the target system and identifies those recovery objects 204 with data that changed between the current recovery point (T5) and the preceding recovery point (T4). Both the preceding recovery point and the list of recovery objects 204 with data that changed may be determined from the respective manifests 304. For example, the recovery objects 204 with data that changed may be determined by comparing the manifests for differences. In the illustrated example, where the system performed an incremental backup at point T5 in block 404, the only recovery objects 204 with timestamp T5 will be those that contain data that changed between T4 and T5. Accordingly, each recovery object 204 stamped T5 in the manifest 304 has data that changed and only those recovery objects 204 with data that changed will be stamped T5 in the manifest 304.

Additionally or in the alternative, a write log 210 local to the target system may be used to identify the data that changed between the current dataset and the preceding recovery point.

Whether determined from a manifest 304 or a write log 210, the recovery module 208 records the recovery objects 204 with data that has changed and/or their associated data extents in a restore log 212 substantially as described above. In the example of FIG. 3, the recovery module 208 determines that data extents: {00000-00999, 05000-05999, and 07000-07999} have data that has been changed between T4 and T5 and records them in the restore log 212.

Referring to block 426 of FIG. 4, the recovery module 208 determines whether the preceding recovery point (T4 in the example) matches the recovery point being restored. If not, the recovery module 208 sets the preceding recovery point (T4) as the current recovery point as shown in block 428. The recovery module 208 then returns to block 424 and identifies from the manifests 304 of the data recovery system 202 those recovery objects 204 and/or data extents with data that changed between the current recovery point (T4) and the preceding recovery point (T3). This may be performed substantially as described above. In the example of FIG. 3, the recovery module 208 determines that data extents: {00000-00999 and 010000-019999} have data that has been changed between T3 and T4, and the recovery module merges these data extents with those already in the restore log 212. The recovery module then repeats the determination of block 426.

The loop ends when the recovery module 208 determines that the preceding recovery point matches the recovery point being restored. In the example of FIG. 3, at that point, the restore log 212 will record that data extents: {00000-00999, 010000-019999, 02000-02999, 05000-05999, and 07000-07999} that differ between T5 and T2.

The method 400 then proceeds to block 416, where, as described above, for each data extent in the restore log, the recovery module 208 identifies from the manifest 304 of the recovery point being restored (e.g., T2) those recovery objects 204 that contain the data as it existed at that point in time. In the example of FIG. 3, recovery objects 204 for recovery point T2 include {00000_T2, 01000_T1, 02000_T0, 05000_T2, and 07000_T0}.

As described above, once the recovery objects 204 of the restore log 212 have been identified, the recovery module 208 retrieves the recovery objects 204 from the data recovery system 202 as shown in block 420 of FIG. 4. Referring to block 422, the recovery module 208 recovers the address space by storing the data contained in the recovery objects 204 on the storage devices 106 at block addresses (physical and/or virtual) determined by the data extents of the respective recovery objects 204. Accordingly, the data is written to the exact block address it was at when it was backed up using address identifiers incorporated into the recovery objects 204. By doing so, the recovery module 208 overwrites the existing data on the storage devices 106 with the data of the recovery objects 204. As will be recognized, only the data that differs between, for example, T5 and T2 (and optionally some unchanged data used to pad out the recovery objects 204) is retrieved from the data recovery system 202 and restored. In this way, the recovery module 208 restores the dataset to its condition at time T5 without restoring each and every recovery object 204 in the address space.

While blocks 424-428 describe a roll-back procedure, blocks 430-434 of FIG. 4 describe an operation when the request specifies a roll-forward to a later version of the dataset. Referring again to FIG. 3, in another example, recovery point T2 corresponds to the dataset as it currently stands on the storage devices 106 of the target system. The request instructs the recovery module 208 to restore recovery point T4, and therefore, the recovery module 208 determines those recovery objects 204 that have changed between recovery point T2 and T4.

Because this is a roll forward, referring to block 430 of FIG. 4, the recovery module 208 identifies those recovery objects 204 with data that changed between the current recovery point (T2) and the subsequent (rather than preceding) recovery point (T3). Both the preceding recovery point and the list of recovery objects 204 with data that changed may be determined from the manifests 304. In one such embodiment, the recovery module 208 identifies the subsequent recovery point by querying the available manifests 304 stored on the data recovery system 202 to identify the recovery point that lists the current recovery point as preceding it. The corresponding recovery point is subsequent to the current one. In the example, the manifest 304 for T3 identifies T2 as the preceding recovery point. Accordingly, T3 is subsequent to T2. In a further such embodiment, the manifest 304 for the current recovery point (T2) includes an entry indicating the subsequent recovery point (T3).

In the example, the subsequent recovery point is an incremental recovery point and contains only those recovery objects 204 with data that changed between the current recovery point and the subsequent recovery point. Accordingly, each recovery object 204 stamped T3 in the manifest 304 has data that changed since T2 and only those recovery objects 204 with data that changed will be stamped T3 in the manifest 304. The recovery module 208 records the recovery objects 204 with data that has changed and/or their associated data extents in a restore log 212 substantially as described above. In the example of FIG. 3, the recovery module 208 determines that data extents: {00000-00999, 01000-01999, 02000-02999, and 07000-07999} have data that has been changed and records them in the restore log 212.

Referring to block 432 of FIG. 4 the recovery module 208 determines whether the subsequent recovery point (T3 in the example) matches the recovery point being restored. If not, the recovery module 208 sets the subsequent recovery point (T3) as the current recovery point as shown in block 434. The recovery module 208 then returns to block 430 and identifies from the manifests 304 those recovery objects 204 and/or data extents with data that changed between the current recovery point (T3) and the next subsequent recovery point (T4). In the example of FIG. 3, the recovery module 208 determines that data extents: {00000-00999, and 01000-01999} have data that has been changed between T3 and T4, and the recovery module 208 merges these data extents with those already in the restore log 212. The recovery module 208 then repeats the determination of block 432.

The loop ends when the recovery module 208 determines that the subsequent recovery point matches the recovery point being restored. In the example of FIG. 3, at that point, the restore log will record that data extents {00000-00999, 01000-01999, 02000-02999, and 07000-07999} that differ between T2 and T4.

The method 400 then proceeds to block 416, where, as described above, for each data extent in the restore log, the recovery module 208 identifies from the manifest 304 of the recovery point being restored (e.g., T4) those recovery objects 204 that contain the data as it existed at that point in time. In the example of FIG. 3, recovery objects 204 for recovery point T4 include {00000_T4, 01000_T4, 02000_T3, and 07000_T3}.

As described above, once the recovery objects 204 of the restore log 212 have been identified, the recovery module 208 retrieves the recovery objects 204 from the data recovery system 202, as shown in block 420 of FIG. 4. Referring to block 422, the recovery module 208 recovers the address space by storing the data contained in the recovery objects 204 on the storage devices 106 at block addresses (physical and/or virtual) determined by the data extents of the respective recovery objects 204. Accordingly, the data is written to the exact block address it was at when it was backed up using address identifiers incorporated into the recovery objects 204. By doing so, the recovery module 208 overwrites the existing data on the storage devices 106 with the data of the recovery objects 204. As will be recognized, only the data that differs between, for example, T2 and T4 (and optionally some unchanged data used to pad out the recovery objects 204) is retrieved from the data recovery system 202 and restored. In this way, the recovery module 208 restores the dataset to its condition at time T4 without restoring each and every recovery object 204 in the address space. Similar to the roll-back, the roll-forward provides a bandwidth-efficient technique for recovering the dataset that leverages the data that is already present and up-to-date on the storage devices.

As will be recognized, the method 400 provides an efficient and reliable technique for roll-back and roll-forward of a dataset. The present embodiments can take the form of an entirely hardware embodiment, an entirely software embodiment, or an embodiment containing both hardware and software elements. Accordingly, it is understood that any of the steps of method 400 may be implemented by a computing system using corresponding instructions stored on or in a non-transitory computer readable medium accessible by the processing system. For the purposes of this description, a tangible computer-usable or computer-readable medium can be any apparatus that can store the program for use by or in connection with the instruction execution system, apparatus, or device. The medium may include non-volatile memory including magnetic storage, solid-state storage, optical storage, cache memory, and Random Access Memory (RAM).

Thus, the present disclosure provides a method, a system, and a non-transitory machine-readable medium for selectively restoring a dataset from an object-based storage system that accounts for a portion of the dataset that has not changed.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
identifying a dataset stored on a set of storage devices and corresponding to a first point in time;
receiving a request to restore the dataset to a second point in time;
identifying a subset of the dataset for which the subset is different between the first point in time and the second point in time;
selectively retrieving data associated with the subset and corresponding to the second point in time; and
merging the selectively retrieved data with the dataset stored on the set of storage devices.

2. The method of claim 1, wherein the retrieved data is structured as at least one data object, and wherein the identifying of the subset includes:
comparing a first manifest recording a first set of data objects associated with a first recovery point to a second manifest recording a second set of data objects associated with a second recovery point to identify a data object that is different between the first set and the second set.

3. The method of claim 1, wherein the identifying of the subset includes tracing a chain of recovery points between the first point in time and the second point in time.

4. The method of claim 3, wherein the identifying of the subset further includes:
for each recovery point in the chain of recovery points, comparing a first manifest recording a first set of data objects associated with the recovery point to a second manifest recording a second set of data objects associated with at least one of: a preceding recovery point or a subsequent recovery point.

5. The method of claim 1, wherein the identifying of the subset includes:
analyzing a local write log recording data extents that have been modified since a previous recovery point.

6. The method of claim 1, wherein the second point in time is previous to the first point and wherein the merging of the selectively retrieved data performs a roll-back of the dataset.

7. The method of claim 1, wherein the second point in time is subsequent to the first point and wherein the merging of the selectively retrieved data performs a roll-forward of the dataset.

8. The method of claim 1 further comprising, in response to the request, creating and storing a set of recovery objects representing the copy of the dataset stored on a set of storage devices.

9. A non-transitory machine-readable medium having stored thereon instructions for performing a method of data recovery, comprising machine executable code which when executed by at least one machine, causes the machine to:
identify a dataset corresponding to a first point in time and a recovery point of the dataset to be restored;
identify data within the dataset at the first point in time that is different from corresponding data associated with the recovery point, wherein the identifying includes comparing a first manifest of recovery objects to a second manifest of recovery objects to identify at least one recovery object that is different therebetween; and
selectively recover the corresponding data associated with the recovery point by retrieving the at least one recovery object.

10. The non-transitory machine-readable medium of claim 9 having stored thereon further instructions that cause the machine to trace a chain of recovery points between the first point in time and the recovery point.

11. The non-transitory machine-readable medium of claim 9 wherein the instructions that cause the machine to identify the data that is different includes instructions that cause the machine to examine a write log that records data extents that have been modified since a previous recovery point.

12. The non-transitory machine-readable medium of claim 9,
wherein the recovery point is previous to the first point in time; and
wherein the instructions that cause the machine to identify the data that is different and selectively recover the corresponding data includes instructions that cause the machine to perform a roll-back of the dataset.

13. The non-transitory machine-readable medium of claim 9,
wherein the recovery point is subsequent to the first point in time; and
wherein the instructions that cause the machine to identify the data that is different and selectively recover the corresponding data includes instructions that cause the machine to perform a roll-forward of the dataset.

14. A computing device comprising:
a memory containing a machine-readable medium comprising machine executable code having stored thereon instructions for performing a method of data recovery; and
a processor coupled to the memory, the processor configured to execute the machine executable code to:
identify a dataset and a recovery point of the dataset to be recovered using a set of data objects stored on a data recovery system;
identify a first subset of the set of data objects that have data that is different from a corresponding portion of the dataset; and
selectively merge the data of the first subset with the dataset without merging data of a second subset of the set of data objects based on the second subset containing data that is not different from the dataset.

15. The computing device of claim 14, wherein the processor is further configured to execute the machine executable code to compare a first recovery object manifest to a second recovery object manifest to identify the first subset.

16. The computing device of claim 14, wherein the processor is further configured to execute the machine executable code to trace a chain of recovery points to identify the first subset.

17. The computing device of claim 14, wherein the processor is further configured to execute the machine executable code to identify the first subset utilizing a write log recording a portion of the dataset that has been modified since a previous recovery point.

18. The computing device of claim 14, wherein the set of data objects corresponds to a first point in time that is before a second point of time associated with the dataset prior to the merge; and wherein the merge performs a roll-back of the dataset.

19. The computing device of claim 14, wherein the set of data objects corresponds to a first point in time that is after a second point of time associated with the dataset prior to the merge; and wherein the merge performs a roll-forward of the dataset.

20. The computing device of claim 14, wherein the processor is further configured to execute the machine executable code to store another set of data object on the data recovery system that represents an incremental backup of the copy of the dataset prior to the merge.
